(19) United States
(12) Patent Application Publication
(10) Pub. No.: US 2014/0360991 A1
(43) Pub. Date: Dec. 11, 2014

(54) Elements for Joining Two Workpiece Parts by Means of Laser Beam Welding

(71) Applicant: JENOPTIK Automatisierungstechnik GmbH, Jena (DE)

(72) Inventors: Christoph Steiner, Jena (DE); Werner Wollmann, Jena (DE)

(21) Appl. No.: 14/296,994

(22) Filed: Jun. 5, 2014

(30) Foreign Application Priority Data
Jun. 6, 2013 (DE) DE102013105881.7

(51) Int. Cl. B23K 26/24

(52) U.S. Cl. CPC B23K 26/24
USPC 219/121.63; 219/121.82

(57) ABSTRACT

A device for connecting two workpiece parts by means of laser beam welding. Producing a simply constructed and cost-effectively manufactured device for flat welding workpiece parts, with simultaneous compensation of workpiece tolerances, is achieved by a weld seam pattern with a number of weld seams arranged downstream of an adapted pressure unit of a laser beam source. The pressure unit has a plurality of channels extending through it with channel walls. The channel walls are a lattice-like arrangement of the first and second pressure elements which have integrated means for compensating tolerances, and which are designed to press the workpiece parts against one another in the z direction.

### RELATED APPLICATIONS

The present application claims priority benefit of German Application No. DE 10 2013 105 881.7 filed on Jun. 6, 2013, the contents of which is incorporated by reference in its entirety.

### FIELD OF THE INVENTION

The invention relates to a device for connecting two workpiece parts by means of laser beam welding, as is known generically from DE 10 2011 055 203 A1.

### BACKGROUND OF THE INVENTION

In laser beam welding, there is a first workpiece part for the laser beam transmission and a second workpiece part for the laser beam absorption. The two workpiece parts are placed one above the other, whereby the transmitting workpiece part faces the laser beam source. The laser beam penetrates the first workpiece part, impinges on the surfaces of the second workpiece part, is absorbed in an area bordering the surfaces, and is converted into heat energy. The surface in the area of the second workpiece part impinged by the laser beam melts, whereby the adjacent portion of the first workpiece part is also melted through heat conductance leading to a material binding of the workpiece parts into one workpiece.

Thus, in order to form a welded joint, the two workpiece parts to be joined together are so superimposed that they are in direct contact along at least one joint surface. Only direct contact allows heat conduction between the workpiece parts. Any remaining air gap would prevent the heat conduction and thus the formation of the weld.

Direct contact at the joint surfaces is usually effected by means of devices specifically adapted to the workpiece parts in order to produce a pressure force by means of which the workpiece parts are pressed together. The devices are so designed that a part of the joint surface is accessible to the laser beam, so that the beam may freely impinge the workpiece parts.

Since most workpiece parts are more or less resilient plastic parts, a variety of these devices have means by means of which any deformation and dimensional tolerances may be compensated by the application of the contact force.

One such device is disclosed in the publication DE 199 24 469 A1. The two workpiece parts to be welded on the periphery are held between two annular pressure elements at their flange-shaped joint faces. The workpiece parts are placed with the flange joint surfaces on a first pressure element. This pressure element is used as a counter support to receive the pressure force. From the other side, the pressure force is applied by a second pressure element to the joint surfaces outside the weld seam to be produced. The supporting surfaces, via which the pressure elements lie on the workpiece parts, are flexible and resilient so that any tolerances of the workpiece parts during pressing may be compensated for, even when selectively differentiated. The second pressure element is so dimensioned that it leaves a portion of the edge area of the workpiece part exposed for the laser beam. Due to the ring-shaped design of at least one of the pressure elements, the weld seam may be made without any break in the edge area of the workpiece. However, the pressure applied to one side of the weld seam may adversely affect the welding result. Because the workpiece parts are heated during the welding, they may be deformed by the pressure force acting on one side, which can result in stresses in the workpiece after cooling, which in turn can lead to deformations. Moreover, a sufficiently large peripheral area of the joint surfaces is always required to allow the application of the second pressure element outside the weld seam.

In a device disclosed in the publication DE 10 2007 042 739 A1, these disadvantages are eliminated in that the pressure forces applied by the second pressure element are distributed on both sides of the weld seam. To this end, the pressure element is constructed in two parts. An inner part inside the weld seam is connected by a plurality of narrow webs to an outer part outside of the weld seam. The weld seam is bridged by the narrow webs. A slight shadowing of the laser beam through the webs is taken into account.

No measures are described that serve to compensate for possible tolerances of the workpiece parts. It is explained that the shape of the supporting surface of the inner part is adapted to the shape of the workpiece parts and the weld seam in order to distribute the pressure force equally. For very small workpiece parts, such an adaptation may still make sense. For larger and more complex shaped workpiece parts, this quickly results in very high production costs.

The solutions of the two aforementioned publications are the same in that the welding is effected around the edges in the edge area of the workpiece parts. The weld seam is always of a linear design.

Should workpiece parts welded next to the edge area also need to be welded with other surfaces, a number of weld seams are required, which advantageously have a comparatively large weld seam width.

From the above-mentioned DE 10 2011 055 203 A1 is disclosed a device for laser transmission welding of two flat workpiece parts extending along a weld seam in the x-y direction, with a laser beam source comprising a plurality of individually controllable laser beam emitters, which together form a line array which is aligned in the x direction with a holder for the workpiece parts, a transport device for transporting the laser beam source relative to the holder in the y direction, and a homogenizer arranged downstream in the beam direction of the laser beam source. The homogenizer is formed by a carrier in which reflection channels are formed, whose cross-sections and dimensions are adapted to the course and the desired width of the weld seams. Two embodiments are disclosed for the design of a homogenizer consisting of a transparent connecting plate e.g. of glass, and a carrier.

The carrier may be made of a solid flat plate, whose thickness determines the length of the channel. The channels may optionally be produced by milling.

Advantageously, the carrier may be formed of two elements, which together include an intermediary space to form a reflection channel.

During welding, the walls of the carrier are under pressure with the surface of the transmitting workpiece part connected, whereby a pressure force is transmitted to the workpiece parts. In the case of workpiece parts curved in the z direction, the walls of the carrier are designed with different lengths as a function of the location, while the end faces of the walls may in part also be at a distance from the surface, whereby they are not involved in the transmission of a pressure force to the workpiece parts. The pressure force is distributed on the surfaces of the workpiece parts via the end faces of the carrier lying against the workpiece parts.

A disadvantage of the design of the homogenizer, which can also be understood to mean a pressure unit, is the required specific design of the carrier to match the course of the weld seams and its fixed arrangement in the direction of the pressure force.

No measures are described for the compensation of the tolerances of the workpiece parts. Were such measures provided in the aforementioned publications, then additional construction elements would always have to be used, such as rubber elements, suspension pins, levers, etc.

### SUMMARY OF THE INVENTION

An object of the present invention is to provide a device for joining two workpiece parts by laser beam welding with an, as simple as possible, and cost-effectively producible, pressure unit, with which the workpiece parts may be flat welded with compensation of workpiece tolerances for a variety of weld seams.

This object is achieved by a device for joining two workpiece parts by means of laser beam welding via a predetermined weld seam pattern consisting of a plurality of weld seams having a holder, a laser beam source, a means of movement, a pressure unit as well as a memory and control unit.

The holder is designed to position two flat workpiece parts extending with respect to one another in the x-y direction, in the x, y and z direction of a Cartesian coordinate system.

The holder and the pressure unit are adjustable with respect to one another in the z direction in order to produce a pressure force oriented in the z direction with which the workpiece parts inserted in the holder are pressed against the pressure unit and consequently pressed against one another. The holder has a pressure cylinder connected to it for this purpose.

The laser beam source bridges the device in the x direction and its beam direction is oriented perpendicularly, i.e. in the z direction, towards the holder and thus to the workpiece parts located in it.

With the movement device, the laser beam source and the holder may be moved relative to one another in the y direction. The laser beam source and the movement device are driven by means of a memory and control unit.

The pressure unit is arranged downstream of the laser beam source in the beam direction. Several channels extend through the pressure unit in the beam direction, whereby the channels have opposing channel walls. The channel walls make it possible that at least a portion of the laser beam directed at the workpiece parts is reflected before impinging on the workpiece parts. The channel walls are designed to press the workpiece parts against one another in the z direction, whereby the shape of the pressure unit is designed to correspond to the three-dimensional shape of the workpiece parts lying on the translucent portion of the workpiece part. The channel walls are formed by a lattice-like arrangement of a plurality of first and second pressure elements oriented in the x and y directions. In this case, the second pressure element oriented in the y direction has integrated means to compensate for tolerances in the z direction, and are thus flexible in the z direction, while the second pressure element oriented in the x direction is shorter in the z direction than the second pressure element oriented in the y direction, so they are not applied to the translucent workpiece part when the second pressure element oriented in the y direction is brought to bear. In the same manner, the second pressure element oriented in the y direction may be shorter when the second pressure element oriented in the x direction has integrated means to compensate for tolerances in the z direction. The first pressure element is rigid in the z direction.

It is advantageous if there is a carrier frame extending in the x-y direction to fix the first and second pressure elements.

In each case, the first and second pressure elements have a plurality of slots through which the first and second pressure elements are inserted in one another in the lattice-like arrangement.

It is advantageous if the second pressure elements with the integrated means for compensating tolerances each have a monolithic structure.

It is advantageous if the means for compensation of tolerances represents a second pressure element arranged in the resilient structure which is arranged on the edges of the second pressure elements on the workpiece parts.

Preferably, the resilient structure may comprise a structure that distributes the pressure force of the second pressure elements uniformly on a plurality of pressure receiving points.

In particular, the resilient structure may distribute the pressure force, starting from a central pressure input point, symmetrically on double the number of pressure receiving points arranged in a cascade.

The reversal of the principle (a pressure force output from the second pressure elements distributed over a number of pressure receiving points) is also conceivable and possible.

It is advantageous to have an adjusting device on the carrier frame for mounting and adjustment of the second pressure elements with respect to the first pressure elements. It is advantageous when further pressure elements are mounted on the first or second pressure elements for receiving the pressure force.

In one possible embodiment, the holder has a resilient yielding support surface for receiving the absorbent workpiece part.

In an alternative design, the pressure elements have a self-supporting structure that replaces the carrier frame and permits dimensioning.

### BRIEF DESCRIPTION OF THE DRAWINGS

The invention will be explained in more detail below with reference to embodiments. In the accompanying drawings:

FIG. 1 shows the basic construction of the device;

FIG. 2a shows a schematic diagram of a second pressure element with integrated means to compensate for tolerances of the workpiece parts;

FIG. 2b shows the principle of uniform distribution of the pressure force via the workpiece parts;

FIG. 2c shows a schematic diagram of a pressure unit in a sectional view;

FIG. 3 shows an example of a weld pattern specially adapted to the workpiece parts; and

FIG. 4 shows a special version of a pressure unit.

### DESCRIPTION OF THE EMBODIMENTS

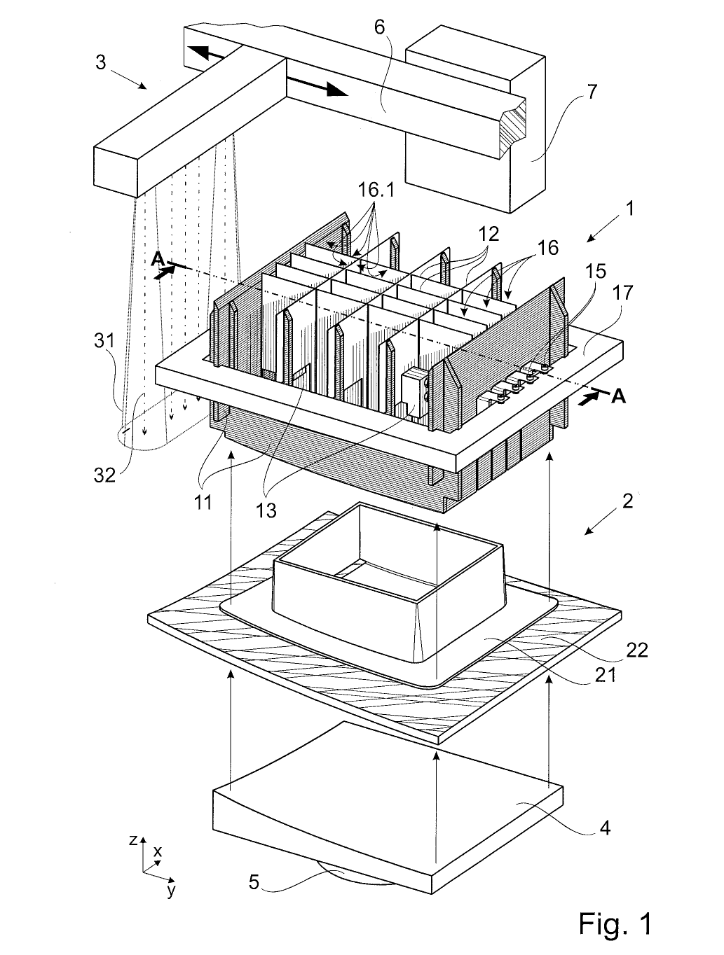

According to a first embodiment illustrated in FIG. 1, the device for laser beam welding has a holder 4 with a pressure cylinder 5, a pressure unit 1, a movement device 6 with a laser beam source 3 and a memory and control unit 7.

An absorbent workpiece part 22 and a translucent workpiece part 21 are inserted into the holder 4 and are welded to form workpiece 2. The absorbent workpiece part 22 is absorbent for the laser beam 31 emitted by the source 3, while the translucent workpiece part 21 is transmissive for the laser beam 31. First the absorbent workpiece 22 and then the translucent workpiece part 21 are inserted in the holder 4, so that the latter faces the laser beam source 3.

By insertion into the holder 4, the workpiece 2 is positioned in the x, y and z directions of a Cartesian coordinate system.

The laser beam source 3 is arranged in the z direction opposite the holder 4. The laser beam 31 emitted by the laser beam source 3 is preferably perpendicular in the likewise oriented beam direction 32 in the z direction to the workpiece 2. The laser beam source 3 is constructed linearly and emits the laser beam 31 in the form of a laser beam curtain extending in the x direction. In this case, it is advantageous for the laser beam source 3 to have several adjacent laser emitters in the x direction.

The laser beam source 3 is arranged to be movable with respect to the holder 4 on the movement device 6 that is positionable in the y direction. The extension of the linear laser beam source 3 in the x direction and a movement range of the movement device 6 in the y direction is at least of such a size that the work piece 2 is completely exposable to the laser beam 31.

The device includes the memory and a control unit 7 to drive the laser beam source 3 and the movement device 6.

The workpiece parts 21, 22 to be welded to the device are primarily flat workpiece parts 21, 22 extending in the x and y directions that may also have three-dimensional protrusions in the z direction, and that are usually welded over a large area. To join by means of laser beam welding, it is necessary that the two workpiece parts 21, 22 form a contact area on the surfaces to be welded, whereby the two workpiece parts 21, 22 contact one another directly. This direct contact of the workpiece parts 21, 22 is distributed uniformly over the surface of the contact area by their being pressed against one another.

The application of a pressure force F required for this purpose is achieved by means of the pressure cylinder 5, with which the holder 4 with the workpiece parts 21, 22 inside, is pressed in the z direction against the pressure unit 1 mounted in the device.

The pressure unit 1 is arranged downstream of the laser beam source 3 in the beam direction 32 to receive the pressure force F, by means of which it is brought to bear on the translucent workpiece part 21.

To ensure the uniform distribution of the pressure force F on the workpiece 2, a special three-dimensional adaptation of the holder 4 and the pressure unit 1 is always required. Therefore, a cost-effectively manufactured pressure unit 1 with a simple structure is essential for the laser beam welding device.

The pressure unit 1 has a lattice-like arrangement of plane plate-shaped pressure elements oriented in the x and y directions. There is at least one first pressure element 11 arranged in the x and y direction that is rigidly fixed in the z direction, and that runs in the z direction when the pressure unit 1 is positioned on the workpiece 2. A plurality of second pressure elements 12 differ according to their orientation in second resilient pressure elements 12 and shortened second pressure elements 12.

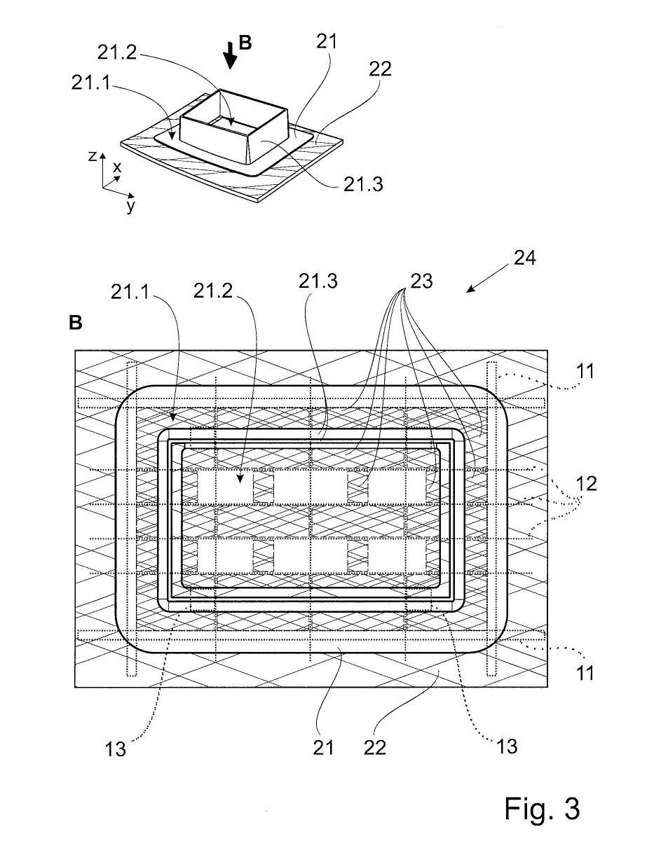

As shown in FIG. 1, the absorbent part of the workpiece part 22 has a curved surface in the z direction. The workpiece parts 21, 22, as shown by the example in FIG. 3, are welded over almost the entire area of the translucent surface of the workpiece part 21. Accordingly, the contact area also extends over the entire surface of the translucent workpiece part 21. In order to form a flat counter support for the holder 4 in this area, the shape of the pressure unit 1 corresponds at least to the side on the translucent workpiece part 21 located in the contact area, exactly matching the three-dimensional shape of the workpiece parts 21, 22. The same is true of holder 4, which applies the pressure force F over the entire workpiece parts 21, 22.

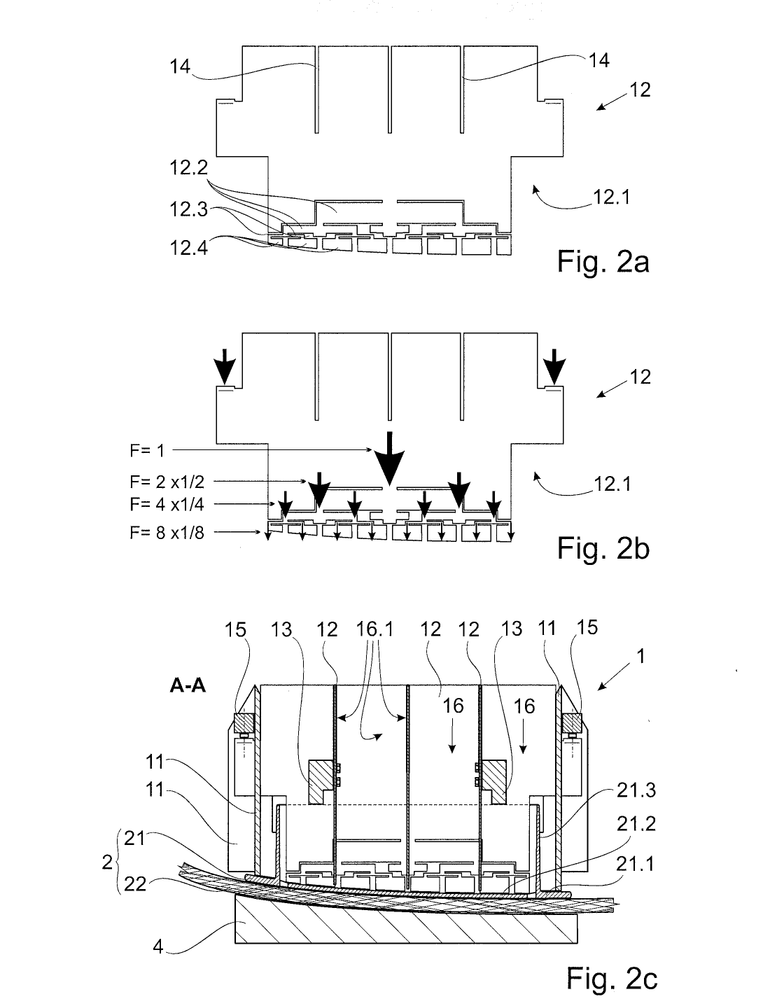

The workpiece 2, as described in this embodiment, has the structure shown in FIG. 1, with a wall structure 21.3 oriented in the z direction. As shown in FIG. 2c in a cross-sectional view of the device, the translucent workpiece part 21 has an inner contact area 21.2 and an outer contact area 21.1. The inner contact area 21.2 is a surface extending in the x-y direction. The outer contact area 21.1 also extends in the x-y direction as a framework-like surface, which completely surrounds the inner contact area 21.2 and which is oriented in the z directed wall structure 21.3.

The pressure unit 1 is a three dimensional structure comprising a plurality of first pressure elements 11 and second pressure elements 12. For this purpose, the pressure elements 11, 12 lie vertically in the z direction intersecting at right angles in one another in the x-y direction, so that they are oriented either in the x or in the y direction to form a lattice arrangement. In order to insert the pressure elements 11, 12 into one another, these are preferably made of flat metal sheets having a favorable sheet thickness in the range 1-3 mm.

For the insertion into one another, the pressure elements 11, 12 are provided with slots at appropriate places extending in the z direction 14. The slots 14 extend approximately to the center of the pressure elements 11, 12. The openings of the slots 14 oriented in the x direction of the pressure elements 11, 12 are arranged opposite to the pressure elements 11, 12 oriented in the y direction. That is to say, for example, a pressure element 11, 12 oriented in the y direction is slotted on the side facing the laser beam source 3, while the pressure element 11, 12 oriented in the x direction is slotted on the side facing the holder 4, so that, on insertion at right angles, the plate oriented in the y direction facing the holder 4 is inserted in the unslotted side in the slot 14 of the plate extending in the x direction, and vice versa.

The first pressure elements 11 are rigid in the z direction and are used to press down on the outer contact area 21.1 outside of the wall structure 21.3. According to the frame-shaped surface of the outer contact area 21.1, a frame-shaped arrangement is likewise made with the first pressure elements 11, which surround the second pressure elements 12. The side facing the holder 4 of the first contact pressure elements 11 are shaped to correspond to the surface of the workpiece 2.

The second pressure elements 12 are used to press the inner contact area 21.2 inside the wall structure 21.3, whereby the pressing is carried out exclusively with resilient second pressure elements 12 that are oriented in the y direction and have means to compensate for tolerances of the workpiece parts 21, 22, and are resilient in the z direction. The second pressure elements 12 oriented in the x direction are shorter in the z direction than the second pressure elements 12 oriented in the y direction.

A resilient structure 12.2 is provided on the second elastic pressure elements 12 on the edges facing the holder 4. The resilient structure 12.2 is integrated into the plate, so that these second pressure elements 12 have a monolithic structure 12.2 in spite of the resilient structure. It is arranged for the plate to be pierced by recesses 12.3. In FIG. 2a, an exemplary profile of the recesses 12.3 is shown on one of the second pressure elements 12 corresponding to the workpiece 2 in FIG. 1. The resilient structure 12.2 ends at the edge facing the holder 4 in the form of a plurality of isolated pressure pieces 12.4 that are distributed at uniform distances over the length of the second pressure elements 12 oriented in the y direction, and coming into contact with a linear-shaped contact surface of the translucent workpiece part 21 when pressed.

The resilient structure 12.2 is so constructed that it distributes the pressure force F acting on the second pressure element 12 uniformly in several symmetrical cascades to pressure pieces 12.4 starting from a central force input point. The principle of distribution is illustrated in FIG. 2b by symbolic arrows in corresponding magnitudes. The resilient structure 12.2 of the second pressure element 12 shown, has three cascade, whereby a doubling of the pressure-receiving points occurs in each of the cascade. The pressure force F received by the central pressure-receiving point is thus equally distributed among the eight pressure pieces 12.4. The pressure pieces 12.4 themselves are again resilient, so that the pressure force F is also uniformly distributed over the area of each linear-shaped supporting surface of the individual pressure pieces 12.4. The resilient structure 12.2 enables point loading of the workpiece 2 to be avoided, whereby such point loading could result in the formation of visible impressions in the workpiece parts 21, 22 on welding.

As shown in FIG. 2a, all of the second pressure elements 12 have lateral recesses 12.1, which are provided for the recess of the wall structure 21.3.

The second pressure elements 12 oriented in the x direction do not lie on the translucent part of the workpiece part 21. They are used exclusively in the lattice-like structure to stabilize the second pressure elements 12 oriented in the y direction.

The lattice-like arrangement of the pressure elements 11, 12 is surrounded by a carrier frame 17 with a rectangular cross-section extending in the x-y direction. The first and second pressure elements 11 and 12 are attached to the carrier frame 17. The carrier frame 17, together with the pressure elements 11, 12, forms the pressure unit 1 against which the workpiece parts 21, 22 are pressed with the holder 4. The pressure unit 1 is received in the device on the carrier frame 17.

In order to align the second pressure element 12 oriented in the y-direction with the resilient structures 12.2 in the pressure unit 1, with respect to one another and opposite the first pressure elements 11, the lateral ends of these second pressure elements 12 are guided into the area of the carrier frame 17. The carrier frame 17 is provided with an adjusting device 15, to which the lateral ends of these second pressure elements 12 are attached by means of a releasable connection. The adjusting device 15 enables these second pressure elements 12 to be adjusted translationally in the z direction and rotationally about the x axis. It is also possible for the adjusting device 15 to establish a prestress between the outer and inner contact areas 21.1 and 21.2 by adding a preset height difference for the successive positioning of the first and second pressure elements 11, 12 on being pressed.

As also shown in FIG. 2c, a further pressure element 13 is used to press the outer contact area 21.1. There are four more almost rectangular pressure elements 13 (only two are visible in FIG. 2c) attached to the second pressure elements 12 oriented in the x-direction, and that lie on the outer contact area 21.1 of the wall structures 21.3.

Corresponding to the number of the second pressure elements 12 arranged in a lattice, a plurality of adjacent channels 16 with parallel opposing duct walls 16.1 extending in the z direction is formed in the pressure unit 1. The channels 16 also have a rectangular cross-section in the x-y direction though the orthogonally arranged pressure elements 11, 12.

The laser beam 31 is focused on the workpiece 2 in the z direction through the channels 16. To generate the laser beam 31, a laser beam source 3 is preferably used to emit a divergent laser beam 31. High power diode lasers are particularly suitable for this purpose and for laser beam welding.

Due to the planar surface of the first and second pressure elements 11 and 12 consisting of plates, the channel walls 16.1 can serve to reflect the divergent laser beam 31 entering the channels 16. By means of the advantageously opposing parallel pressure elements 11, 12, the height of the pressure elements 11, 12 in the z direction and the divergence angle of the laser beam 31, at least a portion of the laser beam 31 is reflected by the channel walls 16.1 prior to impinging on the workpiece 2. The reflection causes mixing of the laser beam 31, so that the otherwise Gaussian-shaped intensity curve of the laser beam 31 is homogenized prior to impingement. This enables particularly homogeneous large-scale welding seams 23 to be produced.

The linear laser beam curtain emitted from the laser beam source 3 scans the workpiece 2 over its entire area in the x direction. The laser beam source 3 is moved with the movement means 6 in the y-direction over the workpiece 2, so that at least the entire surface of the translucent workpiece part 21 may be covered during a relative movement of the laser beam 31.

FIG. 3 shows an example of a weld seam pattern 24 adapted for the workpiece 2 shown in FIG. 1. It can be seen that the weld seam pattern 24 fills almost the entire outer and inner contact areas 21.1 and 21.2. Breaks occur only where the wall structures 21.3 oriented in the z direction prevent transmission of the laser beam 31 through the translucent workpiece part 21, and where the laser beam 31 is shadowed by the pressure elements 11 and 12. The shadowing of the pressure elements 11 and 12 is shown in the weld seam pattern 24 as dotted lines. This shadowing is negligibly small due to the narrow plate thickness.

The positions of the other pressure elements 13 are shown in FIG. 3. The other pressure elements 13 are on the wall structure 21.3. In this way, the outer contact area 21.1 is pressed against both sides of the weld seam 23.

Due to the low shadowing of the second pressure elements 12, it is also possible for the workpiece parts 21, 22 to press closely against the wall structure 21.3 and simultaneously bring the weld seam 23 very close to the wall structures 21.3.

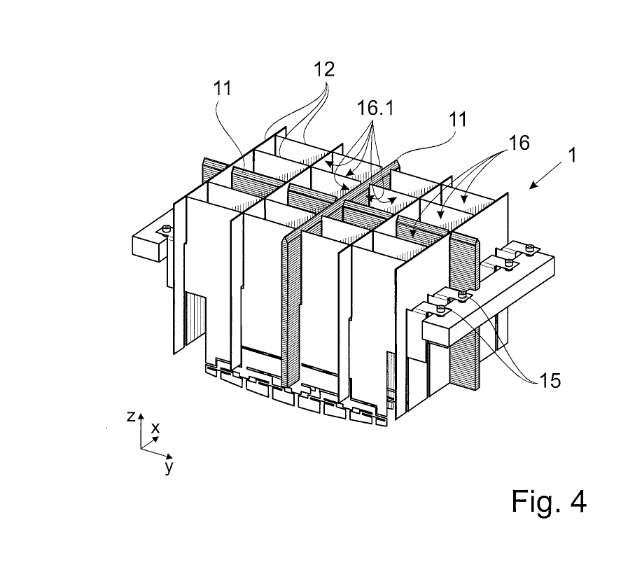

In another embodiment shown in FIG. 4, the pressure unit 1 is constructed without the carrier frame 17. In this way, the pressure elements 11, 12 form a self-supporting structure. The first pressure elements 11 consist of plates with a relatively large thickness. Unlike the first embodiment, only two first pressure elements 11 that intersect centrally are used here. All the other components of the pressure unit 1 are fixed on the first pressure elements 11. The second pressure elements 12 each intersect at their center with the first pressure elements 11. Outside the center, they intersect with the second pressure elements 12 arranged in the other direction of orientation. The second pressure elements 12 are distributed uniformly over the first pressure elements 11 extending in the x or y direction to form the distributed lattice-like arrangement. The second pressure elements 12 oriented in the y direction are received at their ends lateral to the adjusting device 15, which in turn is attached to the first pressure elements 11. Such an arrangement is easier and more cost-effective to produce and is particularly suitable, for translucent workpiece parts 21, which do not have wall structures 21.3 oriented in the z direction.

In other embodiments of the device, it is also possible to apply the pressure force F with the pressure unit 1, which presses the work pieces 21, 22 against the holder 4. To do this, the pressure unit 1 is connected to the pressure cylinder 5, while the holder 4 is rigidly contained within the device.

The holder 4 may have a resilient yielding support surface to receive the absorbent workpiece part 22. The resilient yielding support surface enables the uniform distribution of the pressure force F by selectively yielding to a high pressure force F. In the simplest case, the resilient yielding support surface is a flexible sheet-shaped surface, or a coating of the support surface of the holder 4.

It is also possible to design the apparatus so that the relative movement between the workpiece 2 and the laser beam source 3 is effected together with the holder 4 by a movement of the pressure unit 1. In this way, the pressure unit 1 and the holder 4 are moved in the y direction relative to a stationary laser beam source 3 by means of the movement device 6.

It is equally possible to use a laser beam moved by means of a scanner for the relative movement. The welding of the workpiece parts 21, 22 is then performed through a scanning movement of the laser beam.

Analogously to the scanner, welding may also be effected with the laser beam 31 of a single laser beam emitter, whereby a multiple offset movement relative to the workpiece 2 is effected.

Especially for smaller workpieces 2, it makes sense to use a flat beam as the laser beam source 3, with which the contact area of the workpiece parts 21, 22 is completely covered. In this way, the movement device 6 is not required.

Unlike a rectangular, lattice-like arrangement of the pressure elements 11, 12 in the x-y direction, this may also be arranged at an angle other than 90°. Such an interlocking arrangement can lead to potential better adaptation of pressure unit 1 to the particularities of the workpiece 2.

It is also possible to deviate from the rectangular shape of the pressure unit 1, by designing the pressure unit 1 and the carrier frame 17 to be, for example, circular.

In order to improve the homogenization of the laser beam 31, the laser beam source 3 directed perpendicularly at the workpiece 2 may also be slightly bent. An angulation of up to 10° from the vertical means that the proportion of light of the laser beam 31 reflected from the channel walls 16.1 is increased. This leads to an increased mixing of the laser beams 31 and a more homogeneous weld seam 23.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE NUMERAL LIST

1 Pressure unit
11 First pressure unit
12 Second pressure unit
12.1 Recess
12.2 Resilient structure
12.3 Recess
12.4 Pressure piece
13 Further pressure piece
14 Slot
15 Adjustment device
16 Channel
16.1 Channel wall
17 Carrier frame
2 Workpiece
21 Translucent workpiece part
21.1 Outer contact area
21.2 Inner contact area
21.3 Wall structure
22 Absorbent workpiece part
23 Weld seam
24 Weld seam pattern
3 Laser beam source
31 Laser beam
32 Beam direction
4 Holder
5 Pressure cylinder
6 Movement direction
7 Memory and control unit
F Pressure force

What is claimed is:

1. A device for connecting two workpiece parts by means of laser beam welding via a predetermined weld seam pattern consisting of a plurality of weld seams, comprising a holder designed to position two workpiece parts extending in the x-y direction with respect to one another in the x, y and z directions of a Cartesian coordinate system, a laser beam source having its beam directed in the z direction on the holder, and thus on the workpiece parts positioned therein and spanning the device in the x direction, a movement device for the relative movement of the laser beam source with respect to the holder in the y direction, a pressure unit downstream of the laser beam source that is adjustable in the direction of the beam in the z direction relative to the holder, in which are provided a plurality of channels extending in the direction of the beam through the pressure unit, said channels having opposing channel walls on which at least a portion of said laser beam directed at the workpiece parts is reflected before impinging the workpiece parts and which are adapted to press the workpiece parts against one another in the z direction, and a memory and control unit, said channel walls being formed by a lattice-like array of parallel-plate-shaped first and second pressure elements oriented in the x and y directions, wherein at least one of said first pressure elements is oriented in the x direction and one in the y direction, and is rigid in the z direction, a plurality of second pressure elements being orientation-dependent in shortened second pressure elements that are not adapted to bear against the workpiece parts, and resilient second pressure elements with integrated means to compensate for tolerances in the z direction.

2. The device for joining two workpiece parts according to claim 1, wherein said first and second pressure elements each have a plurality of slots through which said first and second pressure elements are inserted into each other to form a lattice arrangement.

3. The device for connecting two workpiece parts according to claim 1, wherein said second pressure elements have integrated means to compensate for tolerances, each having a monolithic structure.

4. The device for connecting two workpiece parts according to claim 3, wherein said integrated means for compensating for tolerances have a resilient structure in said second pressure elements, and is arranged above edges of said second pressure elements on the workpiece parts.

5. The device for joining two workpiece parts according to claim 4, wherein said resilient structure has a structure in which a pressure force introduced in the second pressure elements is distributed uniformly to a plurality of pressure receiving points.

6. The device for joining two workpiece parts according to claim 5, wherein said resilient structure distributes the pressure force starting from a central pressure input point symmetrically to a plurality of cascade-type doubling number of pressure receiving points.

7. The device for joining two workpiece parts according to claim 1, wherein said pressure unit has a carrier frame extending in the x-y direction, to which are secured the first and second pressure elements, and further comprising an adjusting device provided on said carrier frame for adjusting the second pressure elements with respect to the first pressure elements.

8. The device for connecting two workpiece parts according to claim 1, wherein said first or second pressure elements are provided with further pressure elements to receive said pressure force.

9. The device for joining two workpiece parts according to claim 1, further comprising a resilient yielding support surface provided on said holder, said absorbent workpiece part being laid on said yielding support surface.

10. The device for joining two workpiece parts according to claim 1, wherein said pressure elements have a self-supporting structure to replace said carrier frame for dimensioning.
